(19) United States
(12) Patent Application Publication
(10) Pub. No.: US 2026/0037001 A1
(43) Pub. Date: Feb. 5, 2026

(54) SYSTEMS AND METHODS FOR AUTONOMOUS DOCKING OF POOL CLEANERS

(71) Applicant: ZODIAC POOL CARE EUROPE, Belberaud (FR)

(72) Inventors: Olivier Cam, Toulouse (FR); Mehdi Chafik, Tournefeuille (FR); Benjamin Fontanili, Belberaud (FR); Simon Duffaut, Castelginest (FR)

(73) Assignee: ZODIAC POOL CARE EUROPE, Belberaud (FR)

(21) Appl. No.: 19/285,674

(22) Filed: Jul. 30, 2025

Related U.S. Application Data
(60) Provisional application No. 63/677,792, filed on Jul. 31, 2024.

(51) Int. Cl. G05D 1/661; B60L 53/36; E04H 4/16; G05D 1/249; G05D 105/10; G05D 107/00; G05D 111/10; G05D 111/20; G05D 111/30; G06T 7/70

(52) U.S. Cl. CPC G05D 1/661; E04H 4/1654; G05D 1/249; G06T 7/70; B60L 53/36; B60L 2200/40; G05D 2105/10; G05D 2107/29; G05D 2111/10; G05D 2111/20; G05D 2111/30; G06T 2207/10024; G06T 2207/30252

(57) ABSTRACT

A self-propelled pool cleaner may be operable in a swimming pool or spa. Systems and methods may allow for the pool cleaner to find or locate a docking station within the swimming pool or spa, may allow the pool cleaner to properly dock with the docking station, and/or may allow for the pool cleaner to navigate to a docking station from anywhere within the pool. Docking of the pool cleaner with the docking station may not require physical handling by a user or pool owner.

### REFERENCE TO RELATED APPLICATION

This application claims the benefit of and priority to U.S. Provisional Patent Application No. 63/677,792, filed on Jul. 31, 2024, and entitled SYSTEMS AND METHODS FOR AUTONOMOUS DOCKING OF POOL CLEANERS, the content of which is hereby incorporated by reference in its entirety.

### FIELD OF THE INVENTION

The invention relates to self-propelled swimming pool cleaners and other robots or cleaners, and more particularly, to systems and methods for docking pool cleaners with docking stations.

### BACKGROUND OF THE INVENTION

Numerous self-propelled cleaning devices capable of autonomous or semi-autonomous movement within swimming pools and spas currently exist. The most common of these devices are pool cleaners, which often are either hydraulic or robotic in type. Hydraulic cleaners vary water flow for movement, while robotic cleaners typically employ electric motors to cause motion. Hydraulic pool cleaners, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

Battery-driven pool cleaners are becoming increasingly popular as they may omit the cord or cabling traditionally required for connecting the pool cleaner to an external power source outside of the water of the swimming pool. While such cabling is omitted, battery-driven pool cleaners are only operable while the battery is sufficiently charged. Thus, compared to corded pool cleaners, battery-driven pool cleaners may require charging at various time intervals or frequencies utilizing charging stations. Such time intervals or frequencies may depend on the duration of the cleaning cycle and/or other activities performed by the pool cleaner.

Charging stations for such battery-driven pool cleaners typically may be of two types-a “pool cleaner garage” or a docking station. Pool cleaner garages are embedded inside of the pool wall, stairs, or floor, and usually must be planned during pool construction. Docking stations, on the other hand, are external or out of water of the pool or spa. Regardless of the type of charging station used for charging or re-charging battery-driven pool cleaners, traditional approaches for docking the pool cleaner with the charging station have relied upon a user or pool owner to position the pool cleaner on the charging station.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a method, system, and/or instructions for docking a pool cleaner with a docking station includes causing the pool cleaner to navigate into a docking region of the pool comprising the docking station pursuant to a macro approach protocol, and, after the pool cleaner, is in the docking region, causing the pool cleaner to navigate onto the docking station pursuant to a final approach protocol, wherein the final approach protocol is different from the macro approach protocol.

According to some embodiments, a method, system, and/or instructions for docking a pool cleaner with a docking station includes causing the pool cleaner to navigate into a docking region of the pool comprising the docking station, wherein a size of the docking region is greater than a size docking station, and, after the pool cleaner is in the docking region, causing the pool cleaner to find the docking station within the docking region and navigate into a desired position and/or orientation with the docking station.

According to various embodiments, a method, system, and/or instructions for a pool cleaner include estimating or determining by a pool cleaner a location of the pool cleaner within a swimming pool or spa, determining one or more docking paths to a docking region comprising a docking station based on the estimated or determined location, and causing the pool cleaner to travel along a selected docking path of the one or more docking paths based on the selected docking path meeting a predefined criteria.

According to some embodiments, a method, system, and/or instructions for a pool cleaner include causing a pool cleaner to travel along a perimeter pattern within a swimming pool or spa until the pool cleaner receives a signal from a docking station.

According to certain embodiments, a method, system, and/or instructions for a pool cleaner include obtaining, by a sensor onboard a pool cleaner, one or more radiation signals from one or more locations within a swimming pool or spa, each having a signal characteristic, comparing each signal characteristic with a predefined signal characteristic corresponding to a docking station, and causing the pool cleaner to navigate to a location of the plurality of locations comprising the radiation signal with the signal characteristic matching the predefined signal characteristic.

According to some embodiments, a method, system, and/or instructions for a pool cleaner include scanning, by a pool cleaner, a plurality of locations on one or more walls of a swimming pool or spa using an onboard sensor and obtaining one or more radiation signals, each having a signal characteristic, determining if a radiation signal with a predefined signal characteristic is within the obtained plurality of radiation signals, and causing the pool cleaner to navigate to a location of the plurality of locations comprising the radiation signal with the signal characteristic matching the predefined signal characteristic.

According to various embodiments, a method, system, and/or instructions for a pool cleaner include receiving visual data from a camera of a field of view of a location within a swimming pool or spa, determining if a target object or characteristic is within the field of view based on the visual data, and generating a navigation signal to control a pool cleaner based on the target object or characteristic being within the field of view.

According to some embodiments, pool system includes a docking station positionable within a swimming pool or spa, a pool cleaner movable within the swimming pool or spa, a camera, and a target object or characteristic, wherein the camera is on or proximate to the docking station and the target object or characteristic is on the pool cleaner, or wherein the camera is on the pool cleaner and the target object or characteristic is on the docking station, and wherein the pool cleaner is configured to navigate toward the docking station based on the camera detecting the target object or characteristic in a field of view of a location within the swimming pool or spa.

According to various embodiments, a method, system, and/or instructions for a pool cleaner include receiving, by a pool cleaner, one or more beacon signals from a beacon on or proximate to a docking station, determining a direction of highest intensity of the one or more beacon signals, and orienting the pool cleaner in the direction of highest intensity.

According to certain embodiments, a docking station for a pool cleaner includes a dock configured to receive the pool cleaner and a beacon configured to generate a beacon signal detectable by the pool cleaner, wherein the beacon is spaced apart from and connected to the dock.

According to some embodiments, a method, system, and/or instructions for a pool cleaner include receiving visual data from a camera on or proximate to a docking station of a field of view of a location within a swimming pool or spa, determining based on the visual data whether a pool cleaner is within the field of view, and sending, by the docking station, a navigation command to the pool cleaner based on the detection of the pool cleaner within the field of view.

According to certain embodiments, a pool system includes a docking station with a camera and an underwater communication system and a pool cleaner with an underwater communication system for communicating with the docking station.

According to some embodiments, a method, system, and/or instructions for a pool cleaner include receiving or obtaining an orientation of a docking station within a pool or spa and causing a pool cleaner to orient itself to the orientation of the docking station.

According to certain embodiments, a method, system, and/or instructions for a pool cleaner include receiving visual data from a camera of a pool cleaner of a field of view at least partially comprising a surface of a docking station, identifying, based on the visual data, a visual guide on the surface of the docking station, the visual guide comprising a guide characteristic, and determining a navigation control for the pool cleaner based on the guide characteristic.

According to various embodiments, a pool system includes a pool cleaner with a camera and a docking station with a visual guide on a surface of the docking station.

According to some embodiments, a method, system, and/or instructions for a pool cleaner include receiving sensor data from a sensor of a pool cleaner about a physical property of a surface of a docking station and identifying, based on the sensor data, a navigation control for the pool cleaner based on the physical property.

According to various embodiments, a method, system, and/or instructions for a pool cleaner include providing a plurality of magnetic devices on a docking station in a guiding pattern and guiding a pool cleaner on the docking station based on interaction between a magnetic device on the cleaner and the plurality of magnetic devices.

According to certain embodiments, a method, system, and/or instructions for a pool cleaner include providing a plurality of magnetic devices on a pool cleaner in a guiding pattern, providing a magnetic device on a docking station, and guiding a pool cleaner on the docking station based on interaction between the magnetic device on the docking station and the plurality of magnetic devices of the pool cleaner.

According to certain embodiments, a pool system includes a docking station, a pool cleaner, a plurality of first magnetic devices arranged in a guiding pattern, and at least one second magnetic device, wherein the plurality of first magnetic devices are on the docking station and the at least one second magnetic device is on the pool cleaner, and wherein the at least one second magnetic device is configured to interact with the plurality of first magnetic devices to guide the pool cleaner on the docking station.

According to some embodiments, a docking station for a pool cleaner includes a dock, a beacon movable relative to the dock and configured to generate a beacon source detectable by a pool cleaner, and a control system configured to control a position of the beacon relative to the dock.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a pool system according to embodiments.

FIG. 1A is another view of the pool system of FIG. 1 according to embodiments.

FIG. 2 is another view of the pool system of FIG. 1 according to embodiments.

FIG. 3 is another view of the pool system of FIG. 1 according to embodiments.

FIGS. 4 and 4A are additional views of the pool system of FIG. 1 according to embodiments.

FIG. 5 is another view of the pool system of FIG. 1 according to embodiments.

FIG. 6 is another view of the pool system of FIG. 1 according to embodiments.

FIGS. 7 and 7A are additional views of the pool system of FIG. 1 according to embodiments.

FIG. 8 is another view of the pool system of FIG. 1 according to embodiments.

FIGS. 9 and 9A are additional views of the pool system of FIG. 1 according to embodiments.

FIGS. 10 and 10A are additional views view of the pool system of FIG. 1 according to embodiments.

FIG. 11 is another view of the pool system of FIG. 1 according to embodiments.

FIG. 12 is another view of the pool system of FIG. 1 according to embodiments.

FIG. 13 is another view of the pool system of FIG. 1 according to embodiments.

FIG. 14 is another view of the pool system of FIG. 1 according to embodiments.

### DETAILED DESCRIPTION

Described herein are systems and methods for autonomous docking of self-propelled pool cleaners with docking stations in a swimming pool or spa. Compared to traditional approaches, the systems and methods described herein may allow for the pool cleaner to find or locate the docking station within the pool or spa. The systems and methods described herein may further allow the pool cleaner to properly dock with the docking station (e.g., with a desired orientation and/or position relative to a dock of the docking station). In some embodiments, the systems and methods described herein may allow for the pool cleaner to navigate to a docking station from anywhere within the pool. Optionally, the systems and methods described herein need not require physical handling by a user or pool owner to dock the pool cleaner with the docking station.

In certain embodiments, the systems and methods described herein may provide a macro approach or protocol, in which the pool cleaner may be anywhere within the pool or spa and will move toward the docking station and reach a docking region of the pool. The docking region may be a general area, a neighborhood, or a region within the pool or spa that includes the docking station, but the docking region itself is a size, space, area, etc., greater than the docking station. The docking region may be predefined in some embodiments, although it need not be in other embodiments.

Additionally, or alternatively, the systems and methods described herein may provide a final approach or protocol, in which the pool cleaner within the docking region may move to the docking station so the pool cleaner can position itself in a correct position and/or orientation to charge. The systems and methods described herein with both the macro approach and the final approach may allow for the docking station and/or pool cleaner to use various controls, energy usage, operations, and/or combinations of technologies to provide improved docking.

The systems and methods described herein may guide pool cleaners based on various information or data (sensed and/or provided) as desired. As non-limiting examples, the systems and methods described herein may guide a pool cleaner based on one or more of a localized position of the pool cleaner within the pool or spa, a pool perimeter pattern, trigger signals from a docking station, an optical property of the docking station, a magnetic field of the docking station, an acoustic or sound property of the docking station, a radiation signal property of the docking station, visual data obtained by a camera onboard the pool cleaner, visual data obtained by a camera onboard or associated with the docking station, a beacon signal from a beacon on or associated with the docking station, a compass position or orientation of the docking station, a visual guide on the docking station, a dynamic visual guide on the docking station, a static visual guide on the docking station, a physical property or physical source of the docking station, an arrangement of guides on the docking station and/or on the pool cleaner, combinations thereof, and/or as otherwise desired. Optionally, the docking stations and/or pool cleaners described herein include an onboard control system (processor and/or memory) for controlling and/or causing control of the pool cleaner and/or docking station such that the pool cleaner autonomously docks with the docking station. Various other benefits and advantages may be realized with the systems, devices, and methods provided herein, and the aforementioned advantages should not be considered limiting.

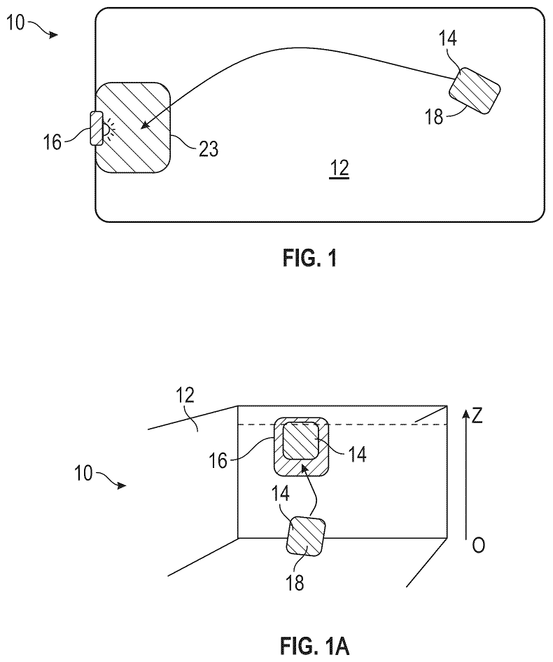

FIG. 1 illustrates an example of a pool system 10 according to embodiments. The pool system 10 generally includes a swimming pool or spa 12 (hereinafter “pool 12”), one or more autonomous or semi-autonomous pieces of pool equipment 14, and a docking station 16 for the pool equipment 14.

In the embodiment illustrated in FIG. 1, the equipment 14 is a pool cleaner 18. Equipment 14 and pool cleaner 18 are used interchangeably in this description, and thus any description of a pool cleaner 18 is equally appliable to pool equipment 14 in general, or vice versa.

In some embodiments, the pool cleaner 18 may be a self-propelled pool cleaner capable of autonomous or semi-autonomous movement within the pool 12. The pool cleaner may be a hydraulic type of pool cleaner, a robotic type of pool cleaner, and/or as otherwise desired. In the embodiment illustrated, the pool cleaner 18 is a robotic pool cleaner using electrical power for movement and cleaning. The pool cleaner 18 generally includes a housing, one or more motive elements for causing movement of the pool cleaner 18 within the pool 12 (e.g., wheels, tracks, propellers, combinations thereof, etc.), and one or more cleaning devices (including but not limited to one or more brush assemblies). A motor, pump, filter, controller, and/or various other features or combinations of features may be provided on or within the pool cleaner 18 as desired. In certain embodiments, the pool cleaner 18 includes an on-board power source, such as but not limited to one or more on-board batteries. Non-limiting examples of pool cleaners 18 may include those described in U.S. Pat. Nos. 10,316,534, 9,488,154, 8,578,538, and U.S. Patent Publication No. 2014/0303810, all of which are hereby incorporated by reference in their entireties.

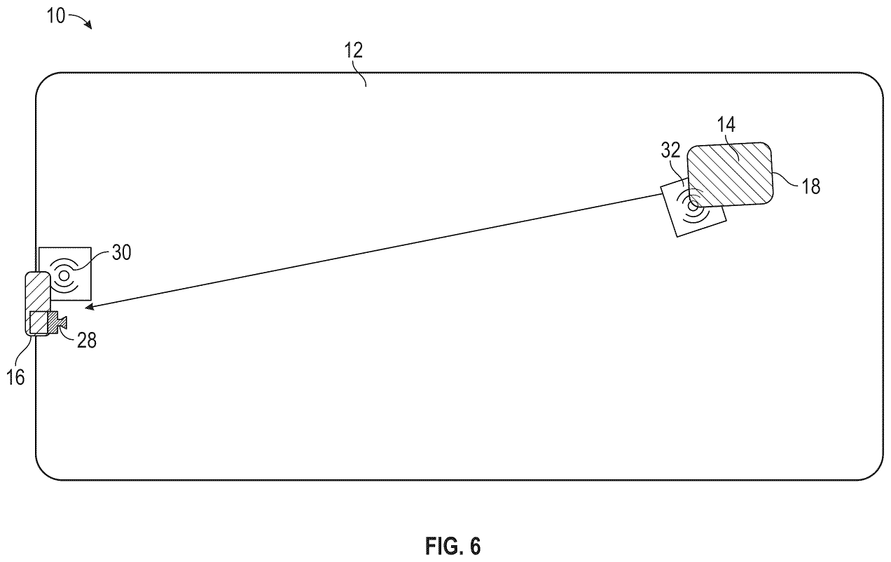

In some embodiments, and as discussed in detail below, the equipment 14 and/or the pool cleaner 18 optionally includes one or more sensors 24 (see, e.g., FIG. 6). Any number of sensors 24 may be utilized, and the one or more sensors 24 may be provided at various locations on the pool cleaner 18 as desired. Various types of sensors 24 may be utilized on the pool cleaner 18 as desired. As non-limiting examples, the one or more sensors may include optical sensors, position sensors, odometry sensors, distance sensors, vibration sensors, magnetic sensors, radio frequency sensors, acoustic sensors, orientation sensors, combinations thereof, and/or as otherwise desired.

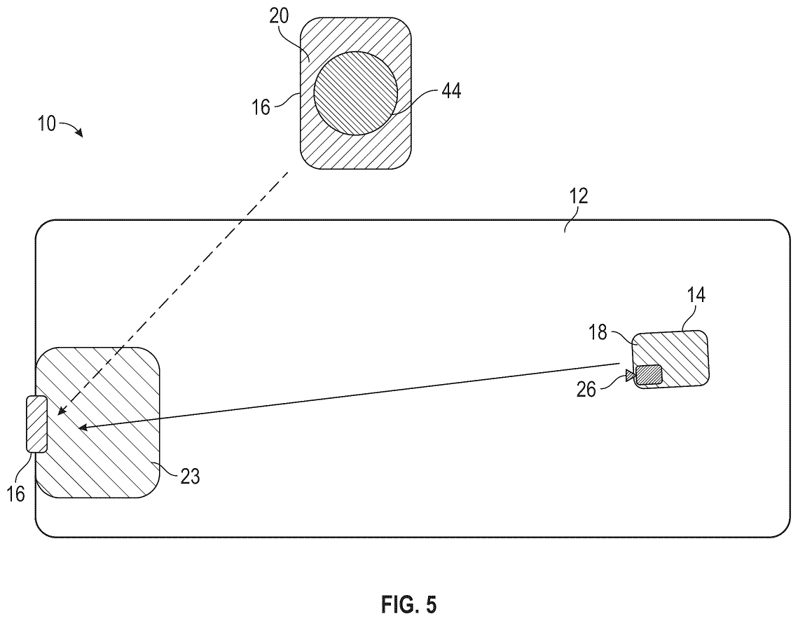

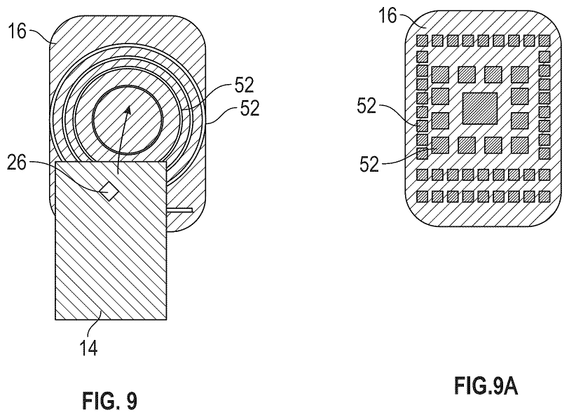

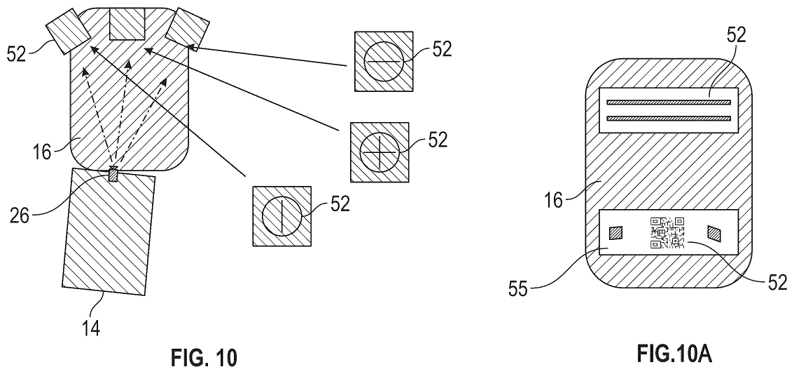

Additionally, or alternatively, and as discussed in detail below, the equipment 14 and/or the pool cleaner 18 optionally includes one or more onboard cameras 26 (see, e.g., FIG. 5). In certain embodiments, each of the one or more cameras 26 has a field of view of a location relative to the pool cleaner 18 and configured to obtain visual data (e.g., images, videos, etc.). The cameras 26 may be provided at various locations on the pool cleaner 18 and/or in various orientations as desired. As non-limiting examples, a camera 26 may be provided on a nominal front end of the cleaner 18 and/or have a field of view of a location in front of the cleaner 18 relative to a direction of travel (see, e.g., FIG. 10), and/or a camera 26 may be provided on a bottom or lower end of the cleaner 18 and/or have a field of view of a location below the cleaner 18 (see, e.g., FIG. 9). Other arrangements, numbers, and/or orientations of cameras 26 may be utilized as desired.

In certain embodiments, the pool cleaner 18 (and/or equipment 14) includes an onboard controller or control system, e.g., one or more processing units and/or one or more memory devices. The processing unit may be various suitable processing devices or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

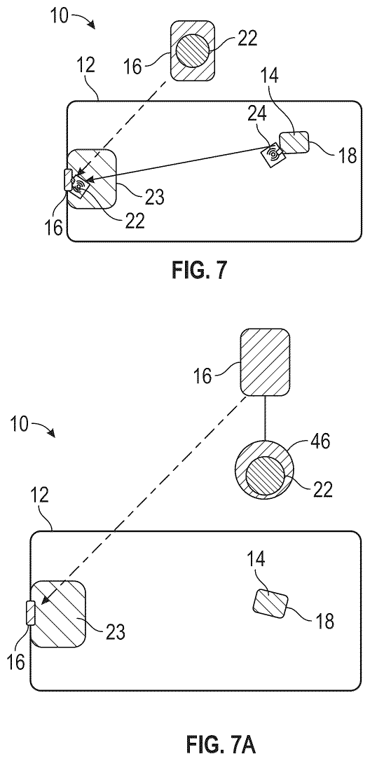

In some embodiments, the pool cleaner 18 (and/or equipment 14) includes one or more communication modules 32 (see, e.g., FIGS. 6 and 7) allowing for wireless communication with external or remote devices such as external control devices, the internet, cloud services, smartphones, other user devices, the docking station 16, other equipment 14, combinations thereof, and/or as otherwise desired. Wireless communication may be various types of communication as desired, such as but not limited to, WiFi, Bluetooth, Bluetooth Low Energy (BLE), cellular, Zigbee, LPWAN, NFC, LiFi, LoRa, combinations thereof, and/or as otherwise desired. In some non-limiting examples, the pool cleaner 18 (and/or equipment 14) may wirelessly communicate with other devices while underwater using various underwater communication techniques as desired. As non-limiting examples, the pool cleaner 18 (and/or equipment 14) may utilize light-based communication (e.g., LiFi), LoRa communication, acoustic communication, physical contact communication, combinations thereof, and/or as otherwise desired.

In other embodiments, other equipment capable of autonomous or semi-autonomous movement may be utilized as desired. In embodiments with a plurality of pieces of pool equipment 14, the pool equipment 14 need not be a same type of equipment 14.

The docking station 16 may allow for in-pool docking, waterline docking, and/or docking outside of the pool with the equipment 14 and/or the pool cleaner 18. The docking station 16 generally includes a dock 20, which may have various constructions suitable for selectively engaging the pool cleaner and/or charging the pool cleaner. As a non-limiting example, the dock 20 may include one or more charging locations for charging an onboard power source of the pool cleaner 18 and/or for communicating with the pool cleaner 18. Various charging features may be utilized at the one or more charging locations, such as but not limited to a feature for contactless charging of the pool cleaner 18 (e.g., via induction). Optionally, the dock 20 may include one or more positioning mechanisms for at least temporarily supporting the pool cleaner 18 on the dock 20 and/or orienting or positioning the pool cleaner relative to the dock 20. Positioning mechanisms may include, but are not limited to, latches, hooks, magnets, electromagnets, combinations thereof, and/or other support mechanisms as desired.

Similar to the equipment 14 and/or the pool cleaner 18, in some embodiments, the docking station 16 may include an onboard control system. In other embodiments, the docking station 16 may communicate with a control system remote from the docking station 16. In such embodiments, the docking station 16 may communicate with the remote control system using various wired or wireless communication as desired.

In various embodiments, and similar to the pool cleaner 18, the docking station 16 optionally may include one or more communication modules 30 (see, e.g., FIG. 6) allowing for wireless communication with external or remote devices such as external control devices, the internet, cloud services, smartphones, other user devices, the pool cleaner 18, other equipment 14, combinations thereof, and/or as otherwise desired.

In some embodiments, and similarly to the pool cleaner 18, the docking station 16 optionally includes one or more cameras 28 (see, e.g., FIGS. 6 and 7) onboard the docking station 16 and/or associated with the docking station 16. Additionally, or alternatively, the docking station 16 optionally includes one or more sensors.

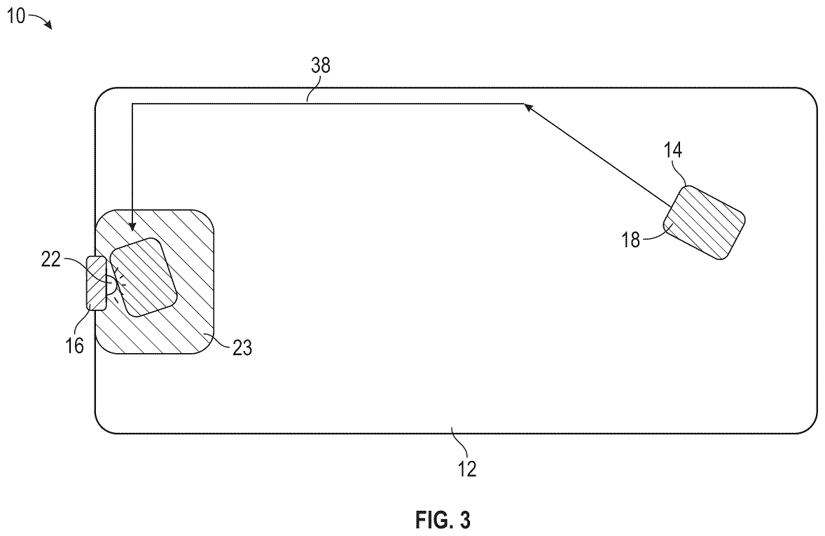

Optionally, and as discussed in detail below, the docking station 16 may include one or more beacons 22 (see, e.g., FIGS. 3, 6, and 12), which may generate a beacon signal detectable by the pool cleaner 18 and/or equipment 14. The beacon signals may be various types of signals as desired, such as but not limited to radiation signals (e.g., optical, magnetic, electromagnetic, acoustic, light, radio, etc.), vibrations, magnetic fields, combinations thereof, and/or as otherwise desired. In some embodiments, and as discussed in detail below, the beacon signals may be triggered responsive to a trigger event. Additionally, or alternatively, the beacon signals may be provided at various intervals and/or as otherwise desired.

In certain embodiments, a docking region 23 of the pool 12 may include the docking station 16. As illustrated in FIG. 1, for example, the docking region 23 may have a shape, size, area, etc. that is greater than that of the docking station 16. In some embodiments, the docking region 23 may be predefined within the pool 12. In other embodiments, the docking region 23 need not be predefined, and instead may be defined based on the location of the docking station 16. As a non-limiting example, regardless of where the docking station 16 is positioned in the pool 12, the docking region 23 may extend some distance from the docking station 16.

In embodiments, various systems and methods may be utilized for guiding the pool cleaner to the docking region 23 (referred to herein as a “macro approach”). Additionally, or alternatively, various systems and methods may be utilized for guiding the pool cleaner 18 to the docking station 16, onto the docking station 16, and/or in a desired position and/or orientation relative to the docking station 16 (referred to herein as a “final approach”). Non-limiting examples of macro approach systems and methods and final approach systems and methods are discussed in greater detail below, but the specific systems and methods described should not be considered limiting. Moreover, while described separately, in certain embodiments, a pool cleaner and/or docking station described herein may utilize a plurality of systems and methods in various combinations and/or sub-combinations as desired for a plurality of macro approaches and/or a plurality of final approaches as desired.

### Macro Approach

FIGS. 1-8 and 12-14 illustrate non-limiting examples of systems and methods for macro approach control of the pool cleaner 18 to the docking station 16. While discussed individually, in certain embodiments, the pool system 10 includes a plurality of features such that a plurality of macro approach controls (as well as final approach controls) may be implemented as desired an in various combinations or sub-combinations as desired.

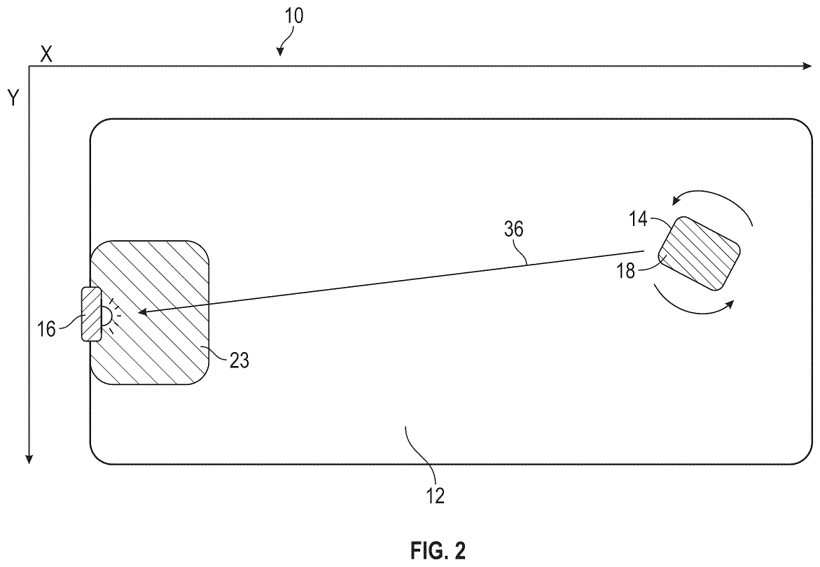

Referring to FIG. 2, in one non-limiting example, a macro approach for guiding the pool cleaner 18 to a docking station may be based on an estimated and/or determined location of the pool cleaner 18 within the pool 12. In these embodiments, the pool cleaner 18 (e.g., via an onboard control system) may know and/or determine its localized position within the pool using various techniques such as but not limited to odometry, location services, position sensors, location sensors, orientation sensors, combinations thereof, and/or as otherwise desired. In these embodiments, the pool cleaner 18 may include various sensors and/or other devices suitable for estimating and/or determining the location of the pool cleaner 18 within the pool 12. In one non-limiting example, the pool cleaner 18 may include a sensor and/or other suitable device or mechanism such that the pool cleaner 18 may know or determine its position (e.g., using odometry, mapping, etc.) along at least two axes (e.g., an x-axis and a y-axis). In certain embodiments, in addition to knowing and/or determining the localized position of the pool cleaner 18, the pool cleaner 18 may also know and/or determine an orientation of the pool cleaner 18 at the localized position using various sensors and/or techniques as desired.

In some embodiments, the pool cleaner 18 additionally may know and/or may determine a localized position of the docking station 16 and/or the docking region 23. As non-limiting examples, the localized position of the docking station 16 and/or the docking region 23 may be supplied to the pool cleaner 18 by a user, detected by the pool cleaner 18 using an onboard sensor or camera, provided to the pool cleaner 18 by the docking station 16 (e.g., the docking station 16 may communicate position information), combinations thereof, and/or as otherwise desired.

In certain embodiments, by knowing and/or determining its localization within the pool 12, the pool cleaner 18 determine a direction to the docking station 16 and/or the docking region 23. In some non-limiting examples, the pool cleaner 18 may determine or calculate one or more docking paths 36 to the docking region 23 based on the estimated or determined location of the pool cleaner 18. Optionally, the one or more docking paths 36 may be determined based on additional information, such as but not limited to obstacles, floor or wall profiles, debris, water features, other equipment, an operational status of the pool cleaner 18, combinations thereof, and/or as otherwise desired.

In some embodiments, the pool cleaner 18 may identity and travel along a selected docking path 36 of the one or more docking paths 36 based on the selected docking path 36 having a path characteristic meeting a predefined criteria. As non-limiting examples, the pool cleaner 18 may select a docking path 36 based on the docking path being a shortest distance to the docking region 23, having a shortest estimated travel time to the docking region 23, a presence of an obstacle (or lack thereof) along the path, a presence of debris (or lack thereof) along the path, combinations thereof, and/or as otherwise desired. In various embodiments, with this determination, the pool cleaner 18 may autonomously return to the docking station 16. In some embodiments, the pool cleaner 18 may autonomously return to the docking station 16 responsive to a trigger event (e.g., an end of a cleaning cycle, a time of day, an environmental condition, a water condition, a status of an onboard battery, a status of an onboard filter, a communication from a user, combinations thereof, etc.) and/or on demand as desired.

Additionally, or alternatively, and referring to FIG. 3, a macro approach for guiding the pool cleaner 18 to the docking station 16 may be based on a pool perimeter pattern and/or sensing. In some embodiments, in this example, the pool cleaner 18 may not necessarily know its location within the pool 12. In certain cases, responsive to a trigger event (e.g., an end of a cleaning cycle, a status of an onboard battery, responsive to an instruction from a user, etc.), the pool cleaner 18 may be controlled (e.g., via an onboard control system) to travel in a perimeter pattern 38 along walls of the pool 12. Optionally, the pool cleaner 18 may be controlled to identify a perimeter wall (e.g., using an onboard sensor, user input, stored information, etc.) of the pool 12 before travelling along the perimeter pattern 38.

In some embodiments, the pool cleaner 18 may be controlled to move along the perimeter pattern until it reaches the docking region 23 or docking station 16. In some embodiments, the docking station 16 may generate a trigger signal (e.g., a light signal, a vibration signal, a sound signal, electromagnetic or magnetic signals, combinations thereof, etc.) which is detectable by the pool cleaner 18. The trigger signal may be generated automatically, and optionally may be provided continuously and/or at various intervals as desired. In one non-limiting example, the trigger signal may be generated based on a detected presence of the pool cleaner 18 by the docking station 16. As a non-limiting example, the docking station 16 may detect (e.g., using an onboard sensor, camera, etc.) the pool cleaner 18 within the docking region 23 and may send the trigger signal responsive to the detection of the pool cleaner 18.

In certain embodiments, the trigger signal may provide a control instruction to the pool cleaner 18 causing the pool cleaner 18 to perform one or more operations. As non-limiting examples, the trigger signal may cause the pool cleaner 18 to stop, navigate in a particular pattern, perform another operation, and/or may provide information to the pool cleaner 18 (e.g., an indication that the pool cleaner 18 is within the docking region 23).

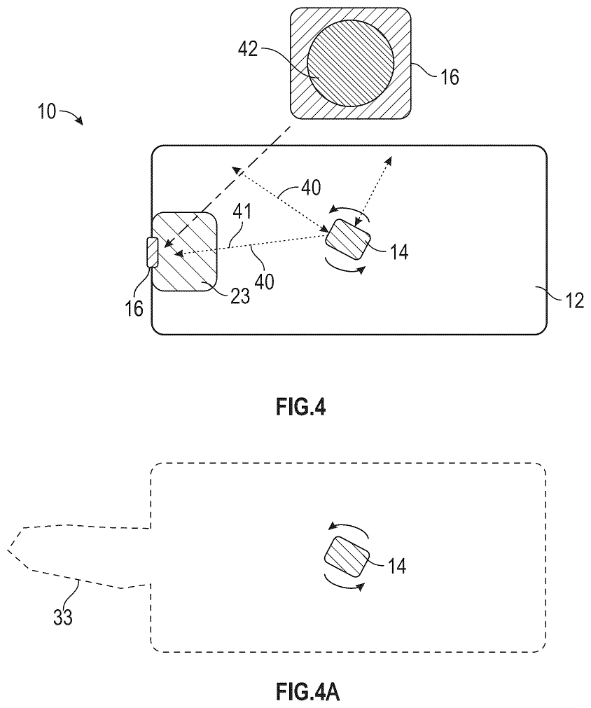

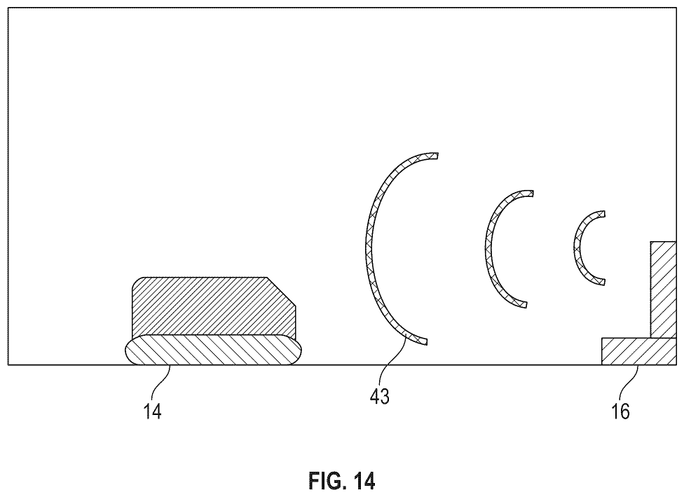

Referring to FIGS. 4 and 14, a macro approach for guiding the pool cleaner 18 to the docking station 16 additionally, or alternatively, may be based on a property or characteristic of a radiation signal 40. In these embodiments, a sensor onboard the pool cleaner 18 may obtain or measure one or more radiation signals 40 from one or more locations within the pool 12, and the pool cleaner 18 may identify the location of the docking station 16 and/or the docking region 23 based on a radiation signal having a predefined property or characteristic.

The radiation signal 40 may be various types of radiation signals as desired, such as but not limited to optical signals, acoustic signals, magnetic or electromagnetic signals, combinations thereof, and/or as otherwise desired. As non-limiting examples, in FIG. 4, the radiation signal 40 is an optical signal 41, and in FIG. 14, the radiation signal 41 is a magnetic field signal 43. In some embodiments, the radiation signal 40 may be generated by the docking station 16. As a non-limiting example, the docking station 16 may emit a sound with a particular property (e.g., intensity, frequency, etc.), and the pool cleaner 18 may identify the location of the docking station 16 by detecting the sound with the property. As a further non-limiting example, and referring to FIG. 14, the docking station 16 may emit the magnetic field signal 43, and the pool cleaner 16 may utilize an onboard sensor to receive the magnetic field signal 43 and orient itself relative to the magnetic field signal 43 (and thus relative to the docking station 43).

In other embodiments, the radiation signal 40 may be generated by the pool cleaner 18. As one non-limiting example, the pool cleaner 18 may include a rangefinder or a time of flight (ToF) system which scans surfaces of the pool 12 using laser or light beams. In this example, and as illustrated in FIG. 4, the docking station 16 optionally may include a detection part or feature 42 configured to reflect the laser or light beam with a specific signature. In various embodiments, the pool cleaner 18 may detect one or more reflected light signals as the radiation signals 40 and identify the location of the docking station 16 based on one of the reflected signals having the specific signature (e.g., due to the detection part or feature 42). FIG. 4A illustrates a non-limiting example of what the pool cleaner 18 may “see” with the ToF system (or other system) whereby the docking station 16 has a specific signature 33. As another non-limiting example, the pool cleaner 18 may generate a sound and may detect a reflected acoustic signal (or echo) as the radiation signal 40. In these embodiments, the docking station 16 optionally may include a detection part or feature 42 configured to modify and/or echo the sound with a specific signature, and the pool cleaner 18 may identify the location of the docking station 16 by detecting an echo with the specific signature.

Optionally, in addition to providing orientation and/or guiding information, in some embodiments, the radiation signals 40 may be utilized to communicate between the docking station 16 and/or the pool cleaner 18. As a non-limiting example, the docking station 16 and the pool cleaner 18 may utilize optical radiation signals 40 for LiFi communication. In these embodiments, such communication may be one-way or two-way as desired. As another non-limiting example, the docking station 16 may control the magnetic field signal 43 to communicate with the pool cleaner 18. Such communication via magnetic field signals 43 optionally may include navigation commands, such as but not limited to, a lift command, a docking command, a stop command, a navigation control command, combinations thereof, and/or as otherwise desired.

Additionally, or alternatively, and referring to FIGS. 5 and 6, a macro approach for guiding the pool cleaner 18 to the docking station 16 may be based on visual data obtained by a camera. In some embodiments, and as illustrated in FIG. 5, the visual data may be from the camera 26 onboard the pool cleaner 18. Additionally, or alternatively, the visual data may be from the camera 28 on the docking station 16 (see, e.g., FIG. 6) and/or other location remote from the docking station 16.

In various embodiments, the visual data from the camera 26 and/or the camera 28 may be analyzed (e.g., by the control system of the pool cleaner 18 and/or the control system of the docking station 16) to determine if a target object is within the visual data. In some embodiments, the target object may be the docking station 16 itself (in FIG. 5) or the pool cleaner 18 itself (in FIG. 6). Additionally, or alternatively, the target object may be various objects or features on the docking station 16 and/or the pool cleaner 18. As non-limiting examples, the target object may be a visual shape, visual pattern, a graphic, a structure, a material, debris, a shape of an onboard light, a color of a light on the pool cleaner 18 and/or the docking station 16, a pattern of an array of lights on the docking station 16 and/or the pool cleaner 18, a blinking frequency of a light on the pool cleaner 18 and/or the docking station 16, combinations thereof, and/or as otherwise desired. As a non-limiting example, in FIG. 5, the docking station 16 includes a target object 44 which includes a green circular shape on the dock 20.

Optionally, the visual data may be analyzed to generate a mapping of at least a portion of the pool 12 and/or a mapping of debris within the pool 12.

In certain embodiments, by identifying the target object 44 in the visual data, the pool cleaner 18 and/or the docking station 16 may determine a general direction of the other. Optionally, the pool cleaner 18 and/or the docking station 16 may calculate or determine the position of the target object 44 relative to the camera providing the visual data or device with the camera.

Referring to FIG. 5, in embodiments where the visual data is from the camera 26 on the pool cleaner 18, responsive to identifying the target object 44 (e.g., the docking station, debris, etc.), the pool cleaner 18 may be controlled to navigate in the direction of the target object 44. Referring to FIG. 6, in embodiments where the visual data is from the camera 28 on the docking station 16, responsive to identifying the target object 44 (e.g., the pool cleaner, debris, etc.), the docking station 16 may send navigation commands or signals to the pool cleaner 18 to control the pool cleaner 18 using various suitable wireless communication techniques (such as but not limited to LiFi communication, LoRa communication, acoustic communication, combinations thereof, and/or as otherwise desired). Navigation commands or signals may cause the pool cleaner 18 to perform various actions, such as but not limited to navigating to the docking station 16, navigating to detected debris, stopping navigation, combinations thereof, and/or as otherwise desired. Optionally, the navigation commands or signals may be sent to the pool cleaner 18 until the pool cleaner 18 reaches the docking region 23 or docking station 16.

Referring to FIGS. 7 and 7A, a macro approach for guiding the pool cleaner 18 to the docking station 16 additionally, or alternatively, may be based on a beacon 22. The beacon 22 may be various suitable devices or mechanisms suitable for generating one or more beacon signals. Non-limiting examples of beacon signals may include, but are not limited to sound, light, magnetic fields, radio, combinations thereof, and/or as otherwise desired. In certain embodiments, the pool cleaner 18 may incorporate a sensor suitable for detecting the beacon signal from the beacon 22, and the pool cleaner 18 may detect the beacon signal while navigating within the pool 12. In some embodiments, the pool cleaner 18 (e.g., via the onboard control system) may identify a direction or location of highest intensity of the beacon signal, and the pool cleaner 18 may control itself by orienting the pool cleaner 18 to face the direction of the highest intensity of the beacon signal. Optionally, the pool cleaner 18 may control itself to navigate in the direction of the highest intensity of the beacon signal, thereby navigating toward the docking station 16 and/or the docking region 23.

The beacon 22 may be provided at various locations on or relative to the docking station 16 as desired. As non-limiting examples, the beacon 22 may be provided on the dock 20 (see, e.g., FIG. 7) or at a location spaced apart or detachable from the dock 20 (see, e.g., FIG. 7A. In embodiments where the beacon 22 is spaced apart from the dock 20, the beacon 22 optionally may be movable or adjustable relative to the dock 20. Optionally, the beacon 22 spaced apart and/or detachable from the dock 20 may include one or more engagement features suitable for engaging the pool cleaner 18. As non-limiting examples, the engagement features 46 may include mechanical hooks, pins, clips, ridges, magnetic hooks, magnetic sources, combinations thereof, and/or other features or devices as desired.

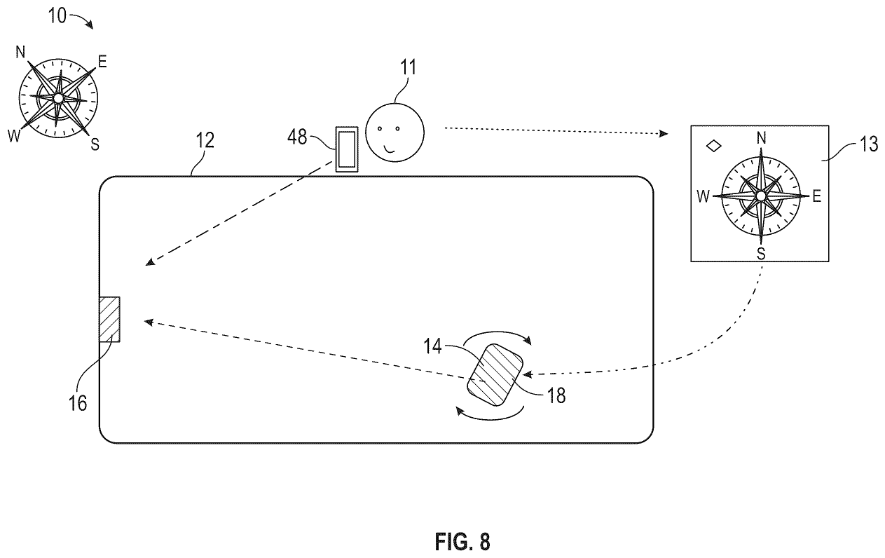

Referring to FIG. 8, a macro approach for guiding the pool cleaner 18 to the docking station 16 additionally, or alternatively, may be based on a compass orientation of the docking station 16 within the pool 12. In some embodiments, the compass orientation of the docking station 16 may be provided to the pool cleaner 18, optionally using a user device 48. As a non-limiting example, a user may identify to the pool cleaner 18 that the docking station 16 is provided along a particular wall (e.g., a north wall, a south wall, an cast wall, a west wall, etc.). Additionally, or alternatively, the pool cleaner 18 may determine the compass orientation of the docking station 16 based on other information from a user. As a non-limiting example, the pool cleaner 18 may receive a picture of the docking station 16 taken by the user device 48 and a compass orientation of the user device 48 when taking the picture, and based on the visual data and the compass orientation data of the user device 48, determine the orientation of the docking station 16. In certain embodiments, the pool cleaner 18 may include an onboard compass orientation sensor (e.g., a compass), and responsive to a trigger event, the pool cleaner 18 may control itself to face the compass orientation of the docking station 16.

The aforementioned examples of macro approaches are for illustrative purposes, and in other embodiments, other macro approaches and/or combinations of macro approaches may be utilized as desired.

### Final Approach

As mentioned, additionally, or alternatively, to macro approaches, the systems and methods may utilize various final approaches for guiding the pool cleaner 18 to the docking station 16, onto the docking station 16, and/or in a desired position and/or orientation relative to the docking station 16. FIGS. 9-14 illustrate non-limiting examples of final approach control of the pool cleaner 18 to the docking station 16. While discussed individually, in certain embodiments, the pool system 10 includes a plurality of features such that a plurality of final approach controls (as well as macro approach controls) may be implemented as desired an in various combinations or sub-combinations as desired.

Referring to FIGS. 9, 9A, 10, and 10A, in one non-limiting example, a final approach for guiding the pool cleaner 18 to the docking station 16 may be based on visual data from a camera on the pool cleaner 18 and one or more visual guides 52 on the docking station 16 (or vice versa). In certain embodiments, the pool cleaner 18 may analyze (e.g., using the onboard control system) the visual data from the camera 26 to detect one or more visual guides 52 and determine a navigation control based on the detected visual guides 52. In these embodiments, the cameras 26 on the pool cleaner 18 may be provided at various locations as desired and/or with various fields of view. In one non-limiting example, and as illustrated in FIG. 9, at least one camera 26 of the pool cleaner 18 may be downward-facing and having a field of view that includes a surface of the dock 20. Additionally, or alternatively, at least one camera 26 may be forward-facing and/or directed to another side of the pool cleaner as desired.

In this embodiment, the visual guides 52 may be various types of visual guides as desired. As non-limiting examples, the visual guides 52 may be shapes, graphics, patterns, colors, lights, arrays of lights, combinations thereof, and/or as otherwise desired. As non-limiting examples, FIG. 9 illustrates visual guides 52 in a ring pattern, and FIG. 9A illustrates a pattern of square visual guides 52. In one non-limiting example, the visual guides 52 may form a path detectable by the camera 26 for guiding the pool cleaner 18 into a proper position and/or orientation on the docking station 16. The visual guides 52 may be provided on various surfaces and/or may be oriented in various directions as desired. As non-limiting examples, FIGS. 9, 9A, and 10A illustrate visual guides 52 on a generally horizontal surface of the dock 16 (facing generally upwards), while FIG. 10 illustrates visual guides 52 on generally vertical surfaces of the dock 16 (facing generally sideways or horizontally). In other embodiments, the guides 52 may be provided in other locations and/or with other orientations as desired and in various combinations or sub-combinations as desired.

In some embodiments, the visual guides may be static. Additionally, or alternatively, the visual guides 52 may be dynamic and/or changing. As non-limiting examples, the visual guides 52 may be a display screen, an array of light sources, combinations thereof, and/or as otherwise desired. FIG. 10A illustrates a non-limiting example of a QR code as a visual guide 52 on a screen 55 on the docking station 16. The visual guides 52 may have various guide characteristics, which may provide location information to the pool cleaner 18 and/or orientation information to the pool cleaner 18. In certain embodiments, the guide characteristics may provide navigation information to the pool cleaner 18. As a non-limiting example, the visual guides 52 detected by the camera 26 of the pool cleaner 18 may cause the pool cleaner 18 to stop movement, change a position of the pool cleaner 18 on the docking station 16, and/or change an orientation of the pool cleaner 18 on the docking station 16.

Additionally, or alternatively, a final approach for guiding the pool cleaner 18 to the docking station 16 may be based on sensor data from a sensor on the pool cleaner 18 and one or more guides on the docking station 16 having specific physical properties. In these embodiments, the physical properties may be various properties such as but not limited to sound, vibrations, micro-vibrations, light, magnetic fields, combinations thereof, and/or as otherwise desired. In these examples, the guides of the docking station 16 may generate one or more physical properties, which the pool cleaner 18 may detect with the sensor. In certain embodiments, the pool cleaner 18 may analyze the detected physical properties (e.g., intensity of the source and/or intensity of frequencies of the source) to determine position information and/or orientation information about the pool cleaner 18 on the docking station 16. As a non-limiting example, the pool cleaner 18 may detect a source of a micro-vibration, and may align itself relative to the source of the micro-vibration. As another non-limiting example, the docking station 16 may include one or more light sources, and the pool cleaner 18 may detect the light sources and align with the light sources to be in a correct position on the docking station 16. Other controls may be implemented as desired.

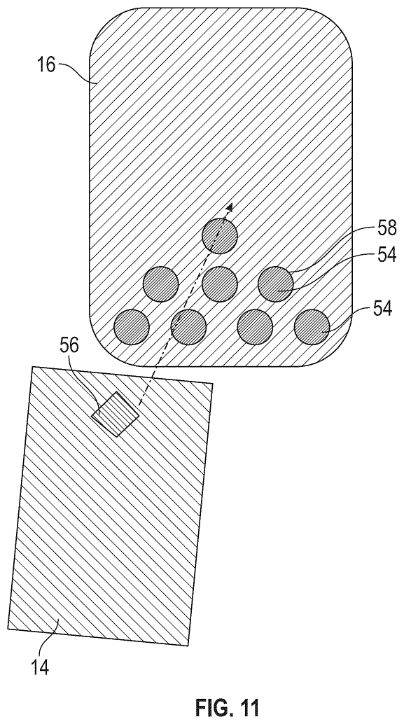

Referring to FIG. 11, additionally, or alternatively, a final approach for guiding the pool cleaner 18 to the docking station 16 may be based on magnetic alignment. In these embodiments, one or more first magnetic devices 54 may be provided on the docking station 16 and one or more second magnetic devices 56 may be provided on the pool cleaner 18. The number of first magnetic devices 54 and/or the number of second magnetic devices 56 should not be considered limiting. The magnetic devices 54, 56 may be various magnetic devices as desired, such as but not limited to magnetic coils, magnets, ferromagnetic pieces, combinations thereof, and/or as otherwise desired. In various embodiments, engagement between the magnetic devices 54, 56 may guide the pool cleaner 18 onto the docking station 16.

In some embodiments, and as illustrated in FIG. 11, a plurality of magnetic devices may be provided in a guiding pattern 58 (e.g., on the docking station 16 and/or on the pool cleaner 18) for directing the pool cleaner 18 as the magnetic devices 54, 56 engage. While a triangle pattern 58 is illustrated, other patterns may be utilized as desired. Optionally, such as embodiments where magnetic devices 54, 56 are magnetic coils, the magnetic devices 54, 56 may be selectively activated and/or deactivated (e.g., sequentially) to guide engagement between the magnetic devices 54, 56 and therefore guide the pool cleaner 18 on the docking station 16.

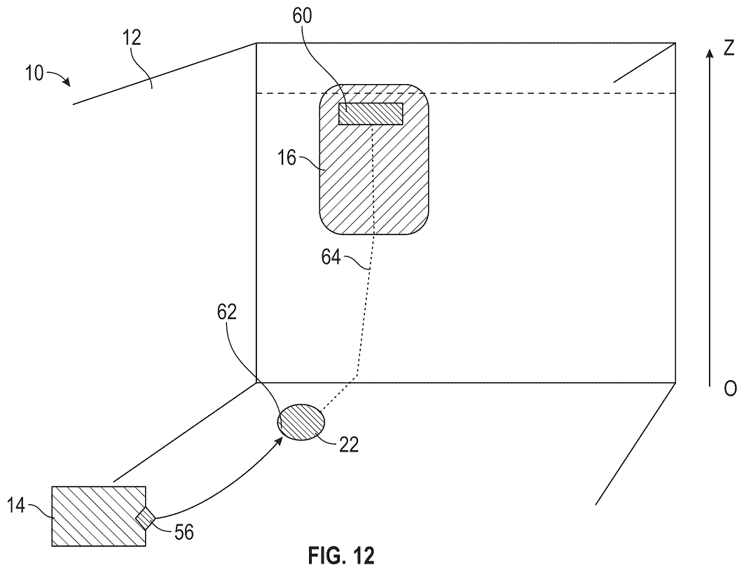

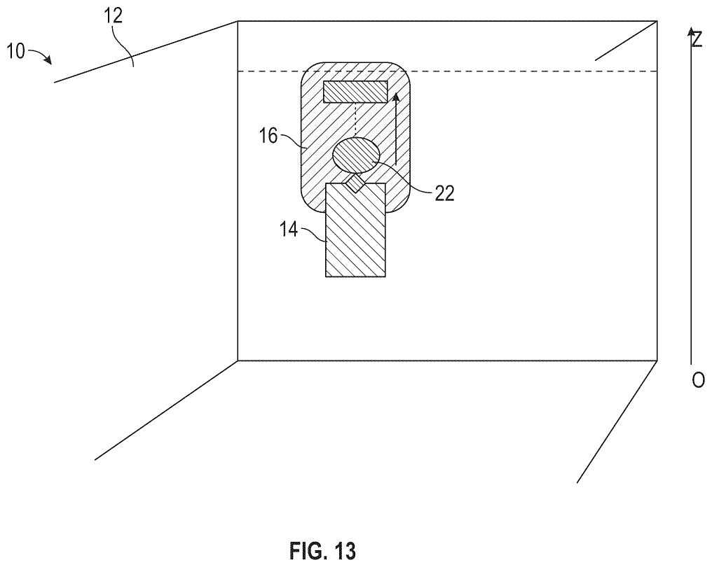

Referring to FIGS. 12 and 13, in some embodiments, the systems and methods described herein utilize a combination macro approach and final approach for guiding the pool cleaner 18 to the docking station 16.

In FIGS. 12 and 13, the docking station 16 includes the dock 20, the beacon 22 movable relative to the dock 20 and configured to generate a beacon source detectable by the pool cleaner 18, and a control system 60 for controlling the position of the beacon 22 relative to the dock 20. In the embodiment of FIGS. 12 and 13, the beacon 22 is configured to generate a magnetic field as the beacon source, and the pool cleaner 18 thus has a corresponding magnetic device 56. However, in other embodiments, other types of beacons and/or beacon sources may be utilized as desired, such as but not limited to light, sound, shapes, images, combination thereof, etc. Optionally, the beacon 22 includes an engagement device 62 for engaging the pool cleaner 18. Various engagement devices 62 may be utilized as desired, such as but not limited to hooks, magnetic hooks, clips, clasps, ridges, combinations thereof, and/or as otherwise desired. In FIGS. 12 and 13, the engagement device 62 is a magnetic hook.

The control system 60 may be various suitable devices or mechanisms for controlling the position of the beacon 22. In one non-limiting example, the control system 60 is a winch system, such as but not limited to a magnetic winch, configured to selectively deploy or retract the beacon 22 utilizing a cable 64. In a deployed position (FIG. 12), the beacon 22 may be spaced apart from the docking station 16, thereby allowing the pool cleaner 18 to be guided into a docking region 23 using a macro approach. In certain embodiments, once the pool cleaner 18 reaches and engages the beacon 22, the engagement device 62 may engage the pool cleaner 18, and the control system 60 may move the beacon 22 to a stowed position (FIG. 13) in which the pool cleaner 18 is properly positioned on the docking station 16, thereby providing a final approach.

The embodiment of FIGS. 12 and 13 should not be considered limiting, and other embodiments may utilize other combinations of macro approaches and/or final approaches as desired.

Various other benefits and advantages may be realized with the systems, devices, and methods provided herein, and the aforementioned advantages should not be considered limiting.

Exemplary concepts or combinations of features of the invention may include:

Statement A. A method of docking a pool cleaner with a docking station, the method comprising: causing the pool cleaner to navigate into a docking region of the pool comprising the docking station pursuant to a macro approach protocol; and after the pool cleaner is in the docking region, causing the pool cleaner to navigate onto the docking station pursuant to a final approach protocol, wherein the final approach protocol is different from the macro approach protocol.

Statement B. A method of docking a pool cleaner with a docking station, the method comprising: causing the pool cleaner to navigate into a docking region of the pool comprising the docking station, wherein a size of the docking region is greater than a size docking station; and after the pool cleaner is in the docking region, causing the pool cleaner to find the docking station within the docking region and navigate into a desired position and/or orientation with the docking station.

Statement C. A method comprising: estimating or determining by a pool cleaner a location of the pool cleaner within a swimming pool or spa; determining one or more docking paths to a docking region comprising a docking station based on the estimated or determined location; and causing the pool cleaner to travel along a selected docking path of the one or more docking paths based on the selected docking path meeting a predefined criteria.

Statement D. The pool cleaner, docking station, system, method, or instructions of any preceding or subsequent statement or combination of statements, wherein determining one or more docking paths comprises determining a plurality of docking paths, each with a path characteristic, and wherein the path characteristic of the selected docking path meets the predefined criteria.

Statement E. The pool cleaner, docking station, system, method, or instructions of any preceding or subsequent statement or combination of statements, wherein the predefined criteria comprises one or more of a shortest path length, a shortest estimated navigation time along the docking path, a presence or absence of debris in the docking path, a presence or absence of an obstacle in the docking path, combinations thereof, and/or as otherwise desired.

Statement F. The pool cleaner, docking station, system, method, or instructions of any preceding or subsequent statement or combination of statements, wherein estimating or determining the location of the pool cleaner further comprises estimating or determining an orientation of the pool cleaner.

Statement G. The pool cleaner, docking station, system, method, or instructions of any preceding or subsequent statement or combination of statements, wherein causing the pool cleaner to travel along the selected path is responsive to a trigger event.

Statement H. The pool cleaner, docking station, system, method, or instructions of any preceding or subsequent statement or combination of statements, wherein the trigger event comprises one or more of an end of a cleaning cycle by the pool cleaner, a time of day, an environmental condition, a water condition, receipt of user input, a battery status of the pool cleaner, combinations thereof, and/or as otherwise desired.

Statement I. A method comprising causing a pool cleaner to travel along a perimeter pattern within a swimming pool or spa until the pool cleaner receives a signal from a docking station.

Statement J. The pool cleaner, docking station, system, method, or instructions of any preceding or subsequent statement or combination of statements, further comprising identifying, by the pool cleaner, a perimeter wall of the swimming pool or spa before travelling along the perimeter pattern.

Statement K. The pool cleaner, docking station, system, method, or instructions of any preceding or subsequent statement or combination of statements, further comprising stopping the pool cleaner responsive to the receipt of the signal from the docking station.

Statement L. The pool cleaner, docking station, system, method, or instructions of any preceding or subsequent statement or combination of statements, further comprising detecting, by the docking station, the pool cleaner within a docking region relative to the docking station, and sending the signal to the pool cleaner responsive to the detection of the pool cleaner.

Statement M. A method comprising: obtaining, by a sensor onboard a pool cleaner, one or more radiation signals from one or more locations within a swimming pool or spa, each having a signal characteristic; comparing each signal characteristic with a predefined signal characteristic corresponding to a docking station; and causing the pool cleaner to navigate to a location of the plurality of locations comprising the radiation signal with the signal characteristic matching the predefined signal characteristic.

Statement N. A method comprising: scanning, by a pool cleaner, a plurality of locations on one or more walls of a swimming pool or spa using an onboard sensor and obtaining one or more radiation signals, each having a signal characteristic; determining if a radiation signal with a predefined signal characteristic is within the obtained plurality of radiation signals; and causing the pool cleaner to navigate to a location of the plurality of locations comprising the radiation signal with the signal characteristic matching the predefined signal characteristic.

Statement O. The pool cleaner, docking station, system, method, or instructions of any preceding or subsequent statement or combination of statements, wherein the radiation signal is an optical signal.

Statement P. The pool cleaner, docking station, system, method, or instructions of any preceding or subsequent statement or combination of statements, wherein the radiation signal is an acoustic signal.

Statement Q. The pool cleaner, docking station, system, method, or instructions of any preceding or subsequent statement or combination of statements, wherein the radiation signal is a magnetic or electromagnetic signal.

Statement R. A method comprising: receiving visual data from a camera of a field of view of a location within a swimming pool or spa; determining if a target object or characteristic is within the field of view based on the visual data; and generating a navigation signal to control a pool cleaner based on the target object or characteristic being within the field of view.

Statement S. The pool cleaner, docking station, system, method, or instructions of any preceding or subsequent statement or combination of statements, wherein the camera is on or associated with the docking station, and wherein the target object or characteristic is on the pool cleaner, and wherein generating the navigation signal comprises sending, by the docking station, a navigation signal to the pool cleaner for causing the pool cleaner to navigate to the docking station.

Statement T. The pool cleaner, docking station, system, method, or instructions of any preceding or subsequent statement or combination of statements, wherein the camera is on or associated with the pool cleaner, and wherein the target object or characteristic is on the docking station, and wherein generating the navigation signal comprises navigating, by the pool cleaner, toward the location comprising the target object or characteristic in the field of view.

Statement U. The pool cleaner, docking station, system, method, or instructions of any preceding or subsequent statement or combination of statements, wherein the target object or characteristic comprises one or more of a shape, a graphic, a color, an image, a display, a visual pattern, a light color, a light shape, a light blinking frequency, a material, debris, combinations thereof, and/or as otherwise desired.

Statement V. A pool system comprising: a docking station positionable within a swimming pool or spa; a pool cleaner movable within the swimming pool or spa; a camera; and a target object or characteristic, wherein the camera is on or proximate to the docking station and the target object or characteristic is on the pool cleaner, or wherein the camera is on the pool cleaner and the target object or characteristic is on the docking station, and wherein the pool cleaner is configured to navigate toward the docking station based on the camera detecting the target object or characteristic in a field of view of a location within the swimming pool or spa.

Statement W. A method comprising: receiving, by a pool cleaner, one or more beacon signals from a beacon on or proximate to a docking station; determining a direction of highest intensity of the one or more beacon signals; and orienting the pool cleaner in the direction of highest intensity.

Statement X. The pool cleaner, docking station, system, method, or instructions of any preceding or subsequent statement or combination of statements, further comprising causing the pool cleaner to navigate in the direction of highest intensity.

Statement Y. The pool cleaner, docking station, system, method, or instructions of any preceding or subsequent statement or combination of statements, wherein the beacon signal comprises one or more of a sound signal, a light signal, a magnetic field signal, a radio frequency signal, combinations thereof, and/or as otherwise desired.

Statement Z. The pool cleaner, docking station, system, method, or instructions of any preceding or subsequent statement or combination of statements, wherein the pool cleaner comprises an onboard sensor configured to receive or detect the one or more beacon signals.

Statement AA. A docking station for a pool cleaner, the docking station comprising: a dock configured to receive the pool cleaner; and a beacon configured to generate a beacon signal detectable by the pool cleaner, wherein the beacon is spaced apart from and connected to the dock.

Statement BB. The pool cleaner, docking station, system, method, or instructions of any preceding or subsequent statement or combination of statements, wherein the beacon is movable relative to the dock.

Statement CC. The pool cleaner, docking station, system, method, or instructions of any preceding or subsequent statement or combination of statements, wherein the beacon comprises a magnetic hook.

Statement DD. A method comprising: receiving visual data from a camera on or proximate to a docking station of a field of view of a location within a swimming pool or spa; determining based on the visual data whether a pool cleaner is within the field of view; and sending, by the docking station, a navigation command to the pool cleaner based on the detection of the pool cleaner within the field of view.

Statement EE. The pool cleaner, docking station, system, method, or instructions of any preceding or subsequent statement or combination of statements, further comprising estimating or determining a position of the pool cleaner relative to the docking station based on the visual data and based on the detection of the pool cleaner in the field of view.

Statement FF. The pool cleaner, docking station, system, method, or instructions of any preceding or subsequent statement or combination of statements, further comprising generating a mapping of a pool environment of the swimming pool or spa based on the visual data, and wherein sending the navigation command comprises sending the mapping of the pool environment.

Statement GG. The pool cleaner, docking station, system, method, or instructions of any preceding or subsequent statement or combination of statements, further comprising identifying or mapping debris in the field of view based on the visual data, and wherein sending the navigation command comprises sending a location or mapping of the debris to the pool cleaner.

Statement HH. The pool cleaner, docking station, system, method, or instructions of any preceding or subsequent statement or combination of statements, further comprising sending the navigation command until the pool cleaner reaches a docking region within the pool or spa comprising the docking station.

Statement II. The pool cleaner, docking station, system, method, or instructions of any preceding or subsequent statement or combination of statements, wherein sending the navigation command comprises sending a LiFi communication, a LoRa communication, an acoustic signal, and/or other underwater communication.

Statement JJ. A pool system comprising: a docking station comprising a camera and an underwater communication system; and a pool cleaner comprising an underwater communication system for communicating with the docking station.

Statement KK. A method comprising: receiving or obtaining an orientation of a docking station within a pool or spa; and causing a pool cleaner to orient itself to the orientation of the docking station.

Statement LL. The pool cleaner, docking station, system, method, or instructions of any preceding or subsequent statement or combination of statements, wherein receiving or obtaining the orientation data comprises: receiving visual data from a camera of a user device, the visual data comprising the docking station; receiving an orientation of the camera; determining an orientation of the dock based on the visual data and the orientation of the camera.

Statement MM. The pool cleaner, docking station, system, method, or instructions of any preceding or subsequent statement or combination of statements, wherein causing the pool cleaner to orient itself is responsive to a trigger event.

Statement NN. A method comprising: receiving visual data from a camera of a pool cleaner of a field of view at least partially comprising a surface of a docking station; identifying, based on the visual data, a visual guide on the surface of the docking station, the visual guide comprising a guide characteristic; and determining a navigation control for the pool cleaner based on the guide characteristic.

Statement OO. The pool cleaner, docking station, system, method, or instructions of any preceding or subsequent statement or combination of statements, further comprising controlling the pool cleaner pursuant to the navigation control.

Statement PP. The pool cleaner, docking station, system, method, or instructions of any preceding or subsequent statement or combination of statements, wherein the navigation control comprises at least one of stopping movement of the pool cleaner, changing a position of the pool cleaner on the surface, and/or changing an orientation of the pool cleaner on the surface.

Statement QQ. The pool cleaner, docking station, system, method, or instructions of any preceding or subsequent statement or combination of statements, wherein the visual guide comprises at least one of a pattern, a shape, a color, or a display.

Statement RR. The pool cleaner, docking station, system, method, or instructions of any preceding or subsequent statement or combination of statements, wherein the visual guide is static.

Statement SS. The pool cleaner, docking station, system, method, or instructions of any preceding or subsequent statement or combination of statements, wherein the visual guide is dynamic, optionally comprising at least one of a display screen and/or a light source.

Statement TT. The pool cleaner, docking station, system, method, or instructions of any preceding or subsequent statement or combination of statements, wherein the visual guide provides position information and orientation information.

Statement UU. A pool system comprising: a pool cleaner comprising a camera; and a docking station comprising a visual guide on a surface of the docking station.

Statement VV. The pool cleaner, docking station, system, method, or instructions of any preceding or subsequent statement or combination of statements, wherein the visual guide is static or dynamic.

Statement WW. The pool cleaner, docking station, system, method, or instructions of any preceding or subsequent statement or combination of statements, wherein the camera is on a bottom of the pool cleaner, optionally downward-facing.

Statement XX. The pool cleaner, docking station, system, method, or instructions of any preceding or subsequent statement or combination of statements, wherein the visual guide comprises a display screen, an array of light sources, or a QR code.

Statement YY. The pool cleaner, docking station, system, method, or instructions of any preceding or subsequent statement or combination of statements, wherein the visual guide comprises a plurality of shapes and/or a pattern of shapes.

Statement ZZ. A method comprising: receiving sensor data from a sensor of a pool cleaner about a physical property of a surface of a docking station; identifying, based on the sensor data, a navigation control for the pool cleaner based on the physical property.

Statement AAA. The pool cleaner, docking station, system, method, or instructions of any preceding or subsequent statement or combination of statements, wherein the physical property comprises a sound, a vibration, a light, or a magnetic field.

Statement BBB. The pool cleaner, docking station, system, method, or instructions of any preceding or subsequent statement or combination of statements, wherein the navigation control is based on a characteristic of the physical property.

Statement CCC. The pool cleaner, docking station, system, method, or instructions of any preceding or subsequent statement or combination of statements, wherein the characteristic comprises an intensity and/or a frequency.

Statement DDD. A method comprising: providing a plurality of magnetic devices on a docking station in a guiding pattern; and guiding a pool cleaner on the docking station based on interaction between a magnetic device on the cleaner and the plurality of magnetic devices.

Statement EEE. A method comprising: providing a plurality of magnetic devices on a pool cleaner in a guiding pattern; providing a magnetic device on a docking station; and guiding a pool cleaner on the docking station based on interaction between the magnetic device on the docking station and the plurality of magnetic devices of the pool cleaner.

Statement FFF. The pool cleaner, docking station, system, method, or instructions of any preceding or subsequent statement or combination of statements, wherein the plurality of magnetic devices comprises coils, magnets, or ferromagnetic pieces.

Statement GGG. The pool cleaner, docking station, system, method, or instructions of any preceding or subsequent statement or combination of statements, wherein guiding the pool cleaner comprises sequentially activating the plurality of magnetic devices.

Statement HHH. The pool cleaner, docking station, system, method, or instructions of any preceding or subsequent statement or combination of statements, wherein the guiding pattern is a triangular or arrow-shaped pattern of the plurality of magnetic devices.

Statement III. A pool system comprising: a docking station; a pool cleaner; a plurality of first magnetic devices arranged in a guiding pattern; and at least one second magnetic device, wherein the plurality of first magnetic devices are on the docking station and the at least one second magnetic device is on the pool cleaner, wherein the at least one second magnetic device is configured to interact with the plurality of first magnetic devices to guide the pool cleaner on the docking station.

Statement JJJ. A docking station for a pool cleaner, the docking station comprising: a dock; a beacon movable relative to the dock and configured to generate a beacon source detectable by a pool cleaner; and a control system configured to control a position of the beacon relative to the dock.

Statement KKK. The pool cleaner, docking station, system, method, or instructions of any preceding or subsequent statement or combination of statements, wherein the control system is a winch system, optionally a magnetic winch.

Statement LLL. The pool cleaner, docking station, system, method, or instructions of any preceding or subsequent statement or combination of statements, wherein the beacon source comprises a light, a sound, a magnetic field, or a visual shape.

Statement MMM. The pool cleaner, docking station, system, method, or instructions of any preceding or subsequent statement or combination of statements, wherein the beacon further comprises an engagement device configured to engage the pool cleaner.

Statement NNN. The pool cleaner, docking station, system, method, or instructions of any preceding or subsequent statement or combination of statements, wherein the engagement device comprises a hook, optionally a magnetic hook.

Statement OOO. A non-transitory computer readable storage medium comprising a plurality of instructions executable by one or more processors, the plurality of instructions comprising instructions which, when executed by the one or more processors, cause the one or more processors to perform actions including the method of any preceding or subsequent statement or combination of statements.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. In the figures and the description, like numerals are intended to represent like elements. Throughout this disclosure, a reference numeral with a letter refers to a specific instance of an element and the reference numeral without an accompanying letter refers to the element generically or collectively. Thus, as an example (not shown in the drawings), device “102A” refers to an instance of a device class, which may be referred to collectively as devices “102” and any one of which may be referred to generically as a device “102.”

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with pool cleaners, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. A method of controlling a self-propelled pool cleaner, the method comprising:
receiving visual data from a camera of a field of view of a location within a swimming pool or spa;
determining if a target object or characteristic is within the field of view based on the visual data; and
generating a navigation signal for controlling the pool cleaner to navigate toward a docking station for the pool cleaner based on the target object or characteristic being within the field of view.

2. The method of claim 1, wherein the camera is on or associated with the docking station, and wherein the target object or characteristic is on the pool cleaner, and wherein generating the navigation signal comprises sending, by the docking station, a navigation signal to the pool cleaner for causing the pool cleaner to navigate to the docking station.

3. The method of claim 1, wherein the camera is on or associated with the pool cleaner, and wherein the target object or characteristic is on the docking station, and wherein generating the navigation signal comprises navigating, by the pool cleaner, toward the location comprising the target object or characteristic in the field of view.

4. The method of claim 1, wherein the target object or characteristic comprises one or more of a shape, a graphic, a color, an image, a display, a visual pattern, a light color, a light shape, a light blinking frequency, a material, debris, or combinations thereof.

5. The method of claim 1, wherein generating the navigation signal comprises:
causing the pool cleaner to navigate into a docking region of the pool comprising the docking station pursuant to a macro approach protocol; and
after the pool cleaner is in the docking region, causing the pool cleaner to navigate onto the docking station pursuant to a final approach protocol, wherein the final approach protocol is different from the macro approach protocol.

6. The method of claim 1, wherein the camera is on or associated with the pool cleaner, wherein the target object or characteristic is a surface of the docking station, and wherein the method further comprises:
identifying, based on the visual data, a visual guide on the surface of the docking station, the visual guide comprising a guide characteristic; and
determining a navigation control for the pool cleaner based on the guide characteristic.

7. The method of claim 1, further comprising:
estimating or determining by a pool cleaner a location of the pool cleaner within a swimming pool or spa; and
determining one or more docking paths to a docking region comprising a docking station based on the estimated or determined location,
wherein generating the navigation signal comprises causing the pool cleaner to travel along a selected docking path of the one or more docking paths based on the selected docking path meeting a predefined criteria.

8. The method of claim 1, further comprising:
obtaining, by a sensor onboard the pool cleaner, one or more radiation signals from one or more locations within a swimming pool or spa, each having a signal characteristic, wherein the one or more radiation signals comprises an optical signal, an acoustic signal, or a magnetic or electromagnetic signal; and
comparing each signal characteristic with a predefined signal characteristic corresponding to the docking station; and
wherein generating the navigation signal comprises causing the pool cleaner to navigate to a location of the one or more locations comprising the radiation signal with the signal characteristic matching the predefined signal characteristic.

9. A pool system comprising:
at least one camera; and
at least one processor operably connected to the at least one camera and configured to receive visual data from the at least one camera, wherein the visual data comprises a field of view of a location within a swimming pool or spa, and wherein the at least one processor is further configured to:
determining if a target object or characteristic is within the field of view based on the visual data; and
generating a navigation signal for controlling a pool cleaner to navigate toward a docking station for the pool cleaner based on the target object or characteristic being within the field of view.

10. The pool system of claim 9, wherein the camera is on or associated with the docking station, and wherein the target object or characteristic is on the pool cleaner, and wherein generating the navigation signal comprises sending, by the docking station, a navigation signal to the pool cleaner for causing the pool cleaner to navigate to the docking station.

11. The pool system of claim 9, wherein the camera is on or associated with the pool cleaner, and wherein the target object or characteristic is on the docking station, and wherein generating the navigation signal comprises navigating, by the pool cleaner, toward the location comprising the target object or characteristic in the field of view.

12. The pool system of claim 9, wherein the camera is on or associated with the pool cleaner, wherein the target object or characteristic is a surface of the docking station, and wherein the at least one processor is further configured to:
identify, based on the visual data, a visual guide on the surface of the docking station, the visual guide comprising a guide characteristic; and
determine a navigation control for the pool cleaner based on the guide characteristic.

13. The pool system of claim 9, further comprising the docking station, wherein the docking station comprises:
a dock configured to receive the pool cleaner; and
a beacon configured to generate a beacon signal detectable by the pool cleaner, wherein the beacon is spaced apart from and connected to the dock.

14. The pool system of claim 9, wherein the at least one processor is configured to control the pool cleaner by:
causing the pool cleaner to navigate into a docking region of the pool comprising the docking station pursuant to a macro approach protocol; and
after the pool cleaner is in the docking region, causing the pool cleaner to navigate onto the docking station pursuant to a final approach protocol, wherein the final approach protocol is different from the macro approach protocol.

15. A non-transitory computer readable storage medium comprising a plurality of instructions executable by one or more processors, the plurality of instructions comprising instructions which, when executed by the one or more processors, cause the one or more processors to perform actions comprising:
receiving visual data from a camera of a field of view of a location within a swimming pool or spa;
determining if a target object or characteristic is within the field of view based on the visual data; and
generating a navigation signal for controlling a pool cleaner to navigate toward a docking station for the pool cleaner based on the target object or characteristic being within the field of view.

16. The non-transitory computer readable storage medium of claim 15, wherein the camera is on or associated with the docking station, wherein the target object or characteristic is on the pool cleaner, and wherein the instructions further comprise instructions which, when executed on the one or more data processors, cause the one or more data processors to perform actions comprising generating the navigation signal by sending, by the docking station, a navigation signal to the pool cleaner for causing the pool cleaner to navigate to the docking station.

17. The non-transitory computer readable storage medium of claim 15, wherein the camera is on or associated with the pool cleaner, wherein the target object or characteristic is on the docking station, and wherein the instructions further comprise instructions which, when executed on the one or more data processors, cause the one or more data processors to perform actions comprising generating the navigation signal comprises navigating, by the pool cleaner, toward the location comprising the target object or characteristic in the field of view.

18. The non-transitory computer readable storage medium of claim 15, wherein the instructions further comprise instructions which, when executed on the one or more data processors, cause the one or more data processors to perform actions comprising:
causing the pool cleaner to navigate into a docking region of the pool comprising the docking station pursuant to a macro approach protocol; and
after the pool cleaner is in the docking region, causing the pool cleaner to navigate onto the docking station pursuant to a final approach protocol, wherein the final approach protocol is different from the macro approach protocol.

19. The non-transitory computer readable storage medium of claim 15, wherein the instructions further comprise instructions which, when executed on the one or more data processors, cause the one or more data processors to perform actions comprising:
identifying, based on the visual data, a visual guide on a surface of the docking station, the visual guide comprising a guide characteristic; and
determining a navigation control for the pool cleaner based on the guide characteristic.

20. The non-transitory computer readable storage medium of claim 15, wherein the instructions further comprise instructions which, when executed on the one or more data processors, cause the one or more data processors to perform actions comprising:
estimating or determining a location of the pool cleaner within the swimming pool or spa; and
determining one or more docking paths to a docking region comprising the docking station based on the estimated or determined location,
wherein generating the navigation signal comprises causing the pool cleaner to travel along a selected docking path of the one or more docking paths based on the selected docking path meeting a predefined criteria.
